(19) United States
(12) Patent Application Publication
(10) Pub. No.: US 2020/0153991 A1
(43) Pub. Date: May 14, 2020

(54) REMOTE PRINTER CONTROL WHEN OPERATIONAL POWER IS DISENGAGED

(71) Applicant: Hewlett-Packard Development Company, L.P., Spring, TX (US)

(72) Inventors: Leslie Caroline Drogo, San Diego, CA (US); William R. James, San Diego, CA (US); James M. Henley, San Diego, CA (US)

(73) Assignee: Hewlett-Packard Development Company, L.P., Spring, TX (US)

(21) Appl. No.: 16/612,859

(22) PCT Filed: Jul. 13, 2017
(86) PCT No.: PCT/US2017/041897

§ 371 Date: Nov. 12, 2019

(51) Int. Cl. H04N 1/00; G06F 3/12

(52) U.S. Cl. CPC H04N 1/00899; G06F 3/1292; H04N 1/00893; G06F 3/1234; G06F 3/121

(57) ABSTRACT

In one example in accordance with the present disclosure, a remote printer control device is described. The remote printer control device includes a power supply and a power interface. The power interface provides power from the power supply to the printer when an operational power supply for the printer is disengaged. A controller of the remote printer control device interfaces with, and controls, the printer when the operational power supply for the printer is disengaged.

### BACKGROUND

Printers are used to deposit a printing compound, such as ink or toner, onto a substrate such as paper. The ink or toner is deposited in patterns to form text, images, or other marks on the substrate. To deposit the printing compound, printers include fluid ejection devices such as printheads. The printheads receive the printing compound from a reservoir or other storage element, and eject the compound on the surface in the desired pattern. In some examples, a printer receives rolls of media, referred to as webs. These media webs are unrolled and passed under a printbar. In some examples, a printbar includes an array of staggered printheads.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a diagram of a remote printer control device and a printer, according to another example of the principles described herein.

FIG. 2 is a block diagram of a remote printer control device for printer control when operational power is disengaged, according to an example of the principles described herein.

FIG. 3 is a schematic diagram of a remote printer control device for printer control when operational power is disengaged, according to another example of the principles described herein.

FIG. 4 is a diagram of a computing system for printer control when operational power is disengaged, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Printers are used to deposit a printing compound, such as ink or toner, onto a substrate such as paper. The ink or toner is deposited in patterns to form text, images, or other marks on the substrate. To deposit the printing compound, printers include fluid ejection devices such as printheads. The printheads receive the printing compound from a reservoir or other storage element, and eject the compound on the surface in the desired pattern. In some examples, printers may be three-dimensional (3D) printers which via a variety of mechanisms print a three-dimensional object. The control device of the present specification can be used to control two-dimensional printers as well as these 3D printers.

In some examples, a printer receives rolls of media, referred to as webs. These media webs are unrolled and passed under a printbar. In some examples, a printbar includes an array of staggered printheads. The width of the printbar, and coverage by the printheads, may be the same as a width of the media. In other words, the printheads of the printbars do not move relative to the media in depositing the print compound.

While these printers have improved the ability to form text and images on media; some characteristics may negatively impact their operation. For example; upon power failure, an entire printer loses power; including the printbars of the printer. If power failure occurs during printing, then the printbars may be uncapped. Moreover, with power removed from the system, there may be no way to cap the printbars and preserve the printheads. If left uncapped; fluid in and around the nozzles of the printheads can harden and crust thereby blocking nozzles and negatively impacting print quality. In other words, printhead health could be adversely affected if power is lost when printbars are in an uncapped state.

Moreover, when performing maintenance it may be desirable to disconnect the printer from its operational power supply. Disconnecting the operational power supply in this fashion increases safety and allows for efficient repair/maintenance on electrical and other components of the printer. However, in removing power from the printer, the interface of the printer; through which maintenance operations are performed; is also unpowered as are motors and other electrical components which operate different printing components.

Accordingly, the present specification describes a remote printer control device that can control a printbar of a printer even when operational power to the printer is disconnected. For example, if upon power outage, a particular printbar is uncapped, the remote printer control device can be individually coupled to the different printbars of a printer and can place each printbar into a capped state; notwithstanding a lack of operational power to the printer. In another example, during maintenance, the printer as a whole can be disconnected from an operational power supply and individual printbars can be powered, and controlled, by the remote printer control device.

Specifically; the present specification describes a remote printer control device that includes a power supply. A power interface of the remote printer control device provides power from the power supply to the printer when an operational power supply for the printer is disengaged. A controller of the remote printer control device interfaces with, and controls, the printer when the operational power supply for the printer is disengaged.

In another example, the remote printer control device includes a remote power supply to provide operational power to the remote printer control device and a printbar of a printer. A power converter of the remote printer control device determines power specifications of the printbar to which the remote printer control device is coupled. A power interface provides power from the power supply to the printbar when an operational power supply for the printbar is disengaged. The power supplied is based on the determined power specifications of the printbar. A controller interfaces with, and controls, the printbar when the operational power supply for the printbar device is disengaged. A user interface of the remote printer control device facilitates control over the printbar.

The present specification also describes a computing system. The computing system includes a processor and a machine-readable storage medium coupled to the processor. An instruction set is stored in the machine-readable storage medium. The instruction set is to be executed by the processor and includes instructions to 1) determine power specifications and control operations available for a printbar of a printer coupled to the remote printer control device, 2) provide power to the remote printer control device and the printbar based on the determined power specifications for the printbar, 3) control the printbar based on the determined control operations available for the printbar and 4) in some cases, updating the instruction set.

In one example, using such a remote printer control device 1) allows for printbar control in the event of power outage, 2) allows printbar and other printer maintenance while the printer is disconnected from an operational power supply, and 3) provides increased control over the different components of the printer. However, it is contemplated that the devices disclosed herein may address other matters and deficiencies in a number of technical areas.

As used in the present specification and in the appended claims, the term “operational power supply” refers to a principal power supply for a printer and a backup power supply for the printer. By comparison, a remote power supplied by the remote power control device refers to a different power supply than the operational power supply. In one example, the principal power supply and/or backup power supply provide power to the printer as a whole, whereas the remote power supplied by the remote power control device may provide power to an individual component, i.e., a printbar, of the printer.

Further, as used in the present specification and in the appended claims, the term “a number of” or similar language is meant to be understood broadly as any positive number including 1 to infinity.

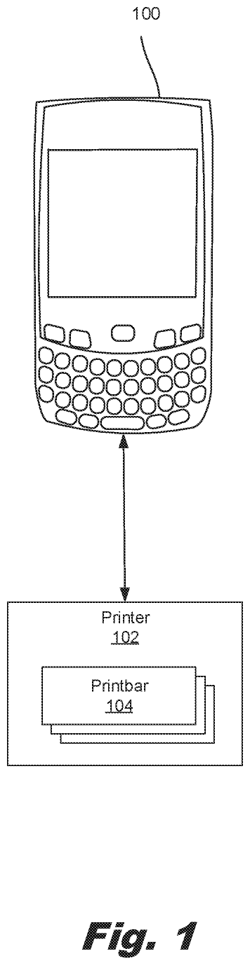

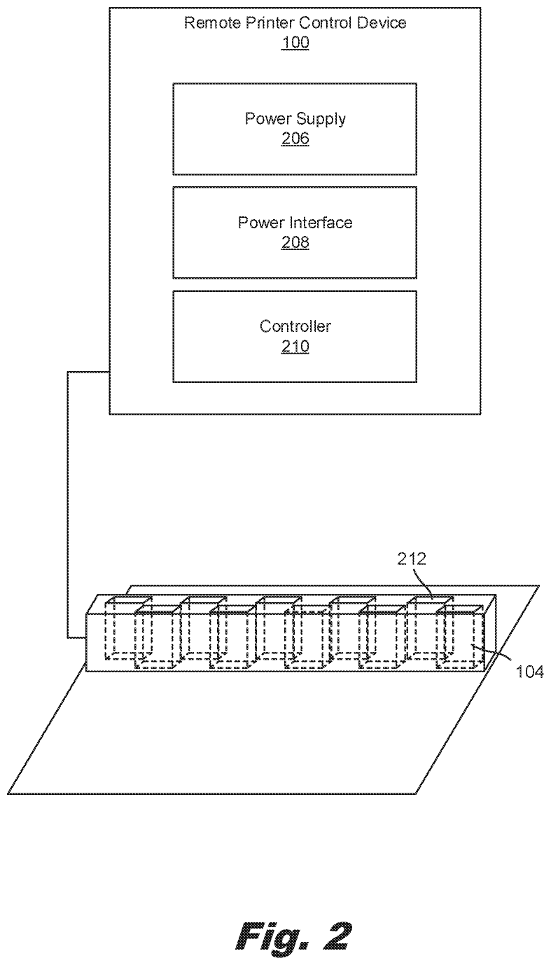

Turning now to the figures, FIG. 1 is a diagram of a remote printer control device (100) and a printer (102), according to an example of the principles described herein. Specifically, FIG. 1 is a diagram of a remote printer control device (100) for printer control when operational power to the printer (102) is disengaged. That is, the remote printer control device (100) allows for remote powering, and control, of printer (102) components when operational power to that printer (102) is disengaged or otherwise disconnected. The remote printer control device (100) may be coupled to any type of printer (102) including a page-wide web press that receives webs of media. A page-wide web press printer (102) includes various printbars (104) that deposit ink along the width of the media and wherein the printheads of the printbar (104) do not to move relative to the media. An example of a single printbar (104) with multiple printheads is provided in FIG. 2.

The operational power supply of the printer (102) may disengage for any number of reasons. For example, during a power outage, power to the printer (102) may inadvertently be disengaged. In another example, operational power could be disengaged intentionally, for example, during maintenance. That is, the operational power source may be disengaged for the safety of a user and/or to allow electrical work to be performed on the printer (102). In these cases, the remote printer control device (100) includes an independent power supply, a power interface, and a controller for providing power to, and controlling, at least a printbar (104) of the printer (102) even when operational power is not supplied to the printer (102).

As clearly indicated in FIG. 1, the remote printer control device (100) may be separate from the printer (102) to which it is coupled. In some examples, the remote printer control device (100) is usable with multiple printers (102). That is to say, the remote printer control device (100) may be universal. For example, the power interface and the controller interface as described below may interface with corresponding interfaces on various types of printers (102). In providing such a universal remote printer control device (100), many types of printbars (104) in many types of printers (102) can be individually powered, independent of an operational power supply.

FIG. 2 is a block diagram of a remote printer control device (100) for printer control when operational power is disengaged, according to an example of the principles described herein. FIG. 2 depicts the printbar (104) and the printheads (212) formed thereon. As described above, a printhead (212) is the mechanism through which ink is deposited on the substrate surface. An array of printheads (212) are distributed along the printbar (104). As indicated in FIG. 2, in some examples, the printbar (104) is a page wide printbar (104) with printheads (212) arrayed to span the printable width across the media. When not in use, a cap is disposed over the printheads (212). That is, the cap is placed, for example via translation or rotation, between the printheads (212) and the substrate. Capping ensures that any of the fluid that passes through nozzles of the printhead (212) does not harden and crust on or around the nozzles, which may block nozzles during subsequent fires, and/or may justify additional cleaning, which additional cleaning wastes time, energy, and other resources.

As described above, during a power outage, an operational power supply may be disengaged from the printer (FIG. 1, 102), meaning that an operational power supply is not providing power to the printer (FIG. 1, 102). Such disengagement may be inadvertent. In another example, a user may intentionally disengage the printer (FIG. 1, 102) from the power supply. In either case, as the printer (FIG. 1, 102) as a whole is not connected to an operational power source, power to the individual printbars (104) of the printer (FIG. 1, 102) is lost as well. Such a disengagement from power to the printbar (104) can have negative consequences both in a power outage scenario as well as a maintenance scenario.

Accordingly, the remote printer control device (100) includes a power supply (206) which provides power to both the remote printer control device (100) and the printbars (104) in the printer (FIG. 1, 102) to which it is coupled. That is, to carry out control operations, the remote printer control device (100) itself draws power, and the printbars (104) also should be coupled to a power source such that they can be moved or otherwise controlled. The provision of this remote power allows the printbars (104) to be placed in a desired state, i.e., a capped state, following a power outage and to be otherwise controlled during a power outage or during scheduled maintenance when power is intentionally removed from the printer (FIG. 1, 102).

The power supply (206) is any device capable of providing power to both the remote printer control device (100) and the printbar (104) to which it is coupled. For example, the power supply (206) may be a pluggable power supply, i.e., an uninterruptible power supply (UPS). In other examples, the power supply (206) may be a remote power supply such as a battery. Implementing a battery as the power supply (206) allows the remote printer control device (100) to operate when power may not be available in the vicinity of the printer (FIG. 1, 102). For example, during a power outage, an entire building may be without power. Accordingly, power may not be readily available via a pluggable source. However, a battery power supply (206), by not relying on the building electricity, would still be able to provide power.

The remote printer control device (100) also includes a power interface (208) to provide power from the power supply (206) to the printbar (104) when an operational power supply for the printer (FIG. 1, 102) is disengaged. In this example, the power interface (208) is coupled with a corresponding interface on the printbar (104) service board such that the individual printbar (104) is powered by the power supply (206). In this example, even though the remaining portions of the printer (FIG. 1, 102) may be powered off, an individual printbar (104) can still be powered via the remote printer control device (100).

As described above, some printers (FIG. 1, 102) have multiple printbars (104). In this example, the remote printer control device (100) is interchangeable between, and individually controls, different printbars (104) at different points in time. That is, for each printbar (104), a user can couple the power interface (208) and controller (210) to the printbar (104) service board. The user can then manipulate the printbar (104) in some fashion. The user can then attach the power interface (208) and controller (210) to another printbar (104) and carry out similar or different operations. Put another way, the remote printer control device (100) is universal across printbars (104) of a printer (FIG. 1, 102).

The remote printer control device (100) also includes a controller (210) to interface with, and control, the printbar (104) when the operational power supply for the printer (FIG. 1, 102) is disengaged. Via the controller (210), various control operations can be carried out on the printbar (104), notwithstanding the operational controller for the printbar (104), i.e., on the printer (FIG. 1, 102), is disengaged due to the decoupling from the operational power supply.

In one example, controlling the printbar (104) includes placing the printbar (104) in a desired state. For example, as described above, if a printbar (104) is uncapped when power is lost, then the printheads (212) may dry up, negatively impacting subsequent printing operations. Accordingly, the controller (210) can place the printbar (104) in a capped state. The controller (210) can place the printbar (104) in a number of other states as well. Other examples of states include a state where the printbar (104) is up and a cap plate, which is a physical cap for the printheads (212) on a printbar (104), is down. In this state, the printheads (212) can be accessed and replaced. Another example is a state where the printbar (104) is up and the cap plate is up. Yet another example is a state where a wiper that cleans the printbar (104) is set to zero height such that the surface of the printheads (212) are height-aligned to be able to be automatically cleaned by the printer service shuttle. In another state, a service shuttle that passes under the printbar (104) moves out from under printheads to perform servicing. In a print ready state, the printbar (104) is placed a few centimeters from the media surface to be able to quickly move to a printing position, but keeping sufficient distance from the media, for example to allow for passing damaged media. As yet another example the printbar (104) can be placed in a standby state.

The controller (210) can also control the printbar (104) by controlling motors or other components within the printbar (104). That is, a printbar (104) includes a number of motors and other components to manipulate the printbar (104). Examples of such components include elevator motors to raise up and lower the printbar (104), service shuttle motors to move a shuttle module relative to the printbar (104), and service wipe cassette motors that move a wiper that cleans the printbar (104), among others. The controller (210) can control these components of the printbar (104). That is, the controller (210) can issue commands for these different components to move by a certain degree. Accordingly, the controller (210) includes logic and operational data for the different components of the printbar (104).

Using the remote printer control device (100) in this fashion increases the efficiency of repairs. For example, a repair could be performed on a particular printbar (104), and just that particular printbar (104) could be activated via the remote printer control device (100) to test the repair and ensure it works before booting up the entire printer (FIG. 1, 102). Thus, this ability to individually activate and control individual components saves time and energy and prevents additional hazards if the repair is unsuccessful.

The remote printer control device (100) as described herein allows for power supplication other than the operational power of a printer (FIG. 1, 102). More specifically, an individual component, i.e., a printbar (104) can be powered, and controlled, while the rest of the printer (FIG. 1, 102) in which the printbar (104) is located is powerless, either intentionally for example during maintenance or unintentionally for example during a power outage.

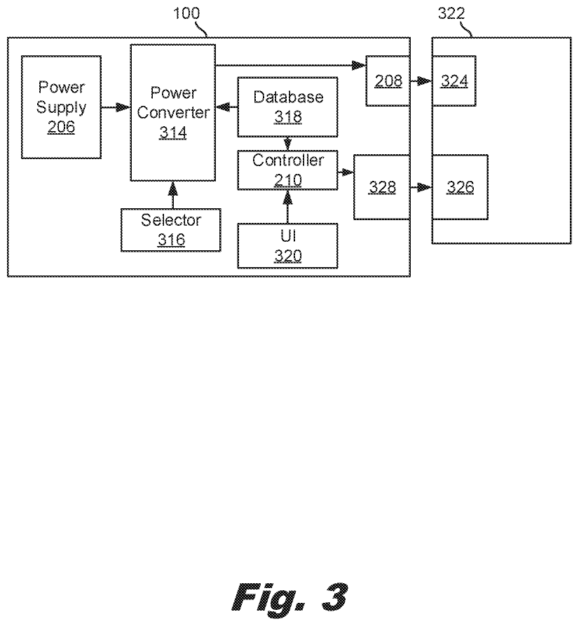

FIG. 3 is a schematic diagram of a remote printer control device (100) for printer control when operational power is disengaged, according to another example of the principles described herein. As described above, the remote printer control device (100) includes a power supply (206) to provide power to the remote printer control device (100) as well as the printbar (FIG. 1, 104). Accordingly, in some examples, the remote printer control device (100) includes a power converter (314) to determine power specifications of the printbar (FIG. 1, 104) to which the remote printer control device (100) is coupled. That is, the power converter (314) receives power from the power supply (206) and translates it into the correct voltage rails for the remote printer control device (100) and the printbar (FIG. 1, 104) to which it is coupled.

As each printbar (FIG. 1, 104) may have different power specifications, the remote printer control device (100) may include a selector (316) to indicate a type of printer (FIG. 1, 102) that the remote printer control device (100) is coupled to. The power converter (314) can then retrieve from the database (318) the power specifications and control operations for the printer (FIG. 1, 102) to which the remote printer control device (100) is coupled. In some examples, the selector (316) may be digital, for example, an icon on a user interface (320). In another example, the selector (316) is a mechanical selector, for example a slider on a side of the remote printer control device (100).

As described above, the remote printer control device (100) may include a database (318) that includes power specifications and control operations for multiple printers (FIG. 1, 102) and printbars (FIG. 1, 104). That is, different models, or types of printers (FIG. 1, 102) may have different power specifications and different components which can be controlled. Accordingly, the database (318) is used by the power converter (314) and the controller (210) in properly providing power and properly controlling the printbar (FIG. 1, 104).

Power is then provided to a service board (322) of the printbar (FIG. 1, 104) and the controller (210) can issue commands to the service board (322). That is, each printbar (FIG. 1, 104) includes a service board (322) that controls that printbar (FIG. 1, 104). Specifically, the service board (322) controls operations of motors that control the motion of the printbar (FIG. 1, 104), caps, and service shuttles that can wipe and clean the printheads (FIG. 2, 212). Accordingly, the power interface (208) and a controller interface (328) are selectively coupled with corresponding interfaces (324, 326) on the service board (322).

A user interface (320) of the remote printer control device (100) allows users to carry out the different operations over the printbar (FIG. 1, 102). For example, the user interface may allow for selection of a desired state for a printbar (FIG. 1, 104). The printbar (FIG. 1, 104) is then controlled by the remote printer control device (100) to enter the selected state.

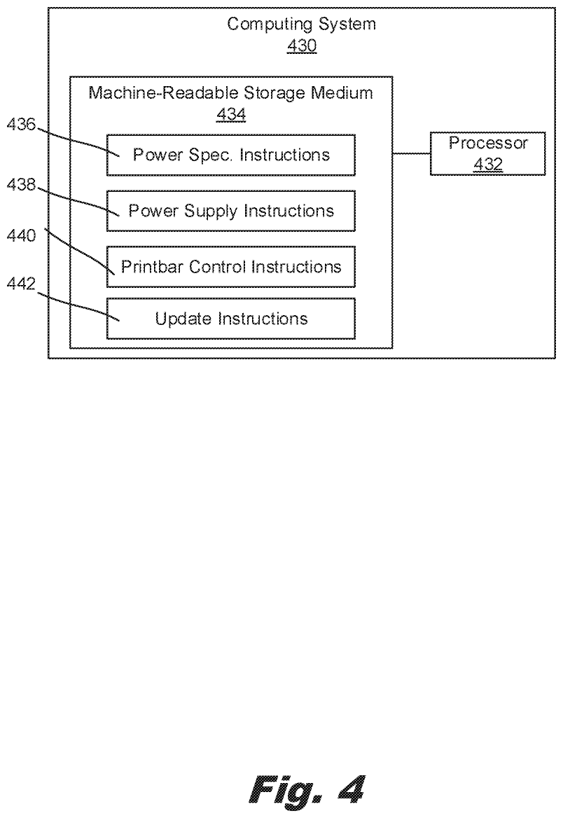

FIG. 4 is a diagram of a computing system (430) for printer control when operational power is disengaged, according to an example of the principles described herein. To achieve its desired functionality, the computing system (430) includes various hardware components. Specifically, the computing system (430) includes a processor (432) and a machine-readable storage medium (434). The machine-readable storage medium (434) is communicatively coupled to the processor (432). The machine-readable storage medium (434) includes a number of instruction sets (436, 438, 440, 442) for performing a designated function. The machine-readable storage medium (434) causes the processor (432) to execute the designated function of the instruction sets (436, 438, 440, 442).

Although the following descriptions refer to a single processor (432) and a single machine-readable storage medium (434), the descriptions may also apply to a computing system (430) with multiple processors and multiple machine-readable storage mediums. In such examples, the instruction sets (436, 438, 440, 442) may be distributed (e.g., stored) across multiple machine-readable storage mediums and the instructions may be distributed (e.g., executed by) across multiple processors.

The processor (432) may include at least one processor and other resources used to process programmed instructions. For example, the processor (432) may be a number of central processing units (CPUs), microprocessors, and/or other hardware devices suitable for retrieval and execution of instructions stored in machine-readable storage medium (434). In the computing system (430) depicted in FIG. 4, the processor (432) may fetch, decode, and execute instructions (436, 438, 440, 442) for remote printer control when operational power is disengaged. In one example, the processor (432) may include a number of electronic circuits comprising a number of electronic components for performing the functionality of a number of the instructions in the machine-readable storage medium (434). With respect to the executable instruction, representations (e.g., boxes) described and shown herein, it should be understood that part or all of the executable instructions and/or electronic circuits included within one box may, in alternate examples, be included in a different box shown in the figures or in a different box not shown.

The machine-readable storage medium (434) represent generally any memory capable of storing data such as programmed instructions or data structures used by the computing system (430). The machine-readable storage medium (434) includes a machine-readable storage medium that contains machine-readable program code to cause tasks to be executed by the processor (432). The machine-readable storage medium (434) may be tangible and/or non-transitory storage medium. The machine-readable storage medium (434) may be any appropriate storage medium that is not a transmission storage medium. For example, the machine-readable storage medium (434) may be any electronic, magnetic, optical, or other physical storage device that stores executable instructions. Thus; machine-readable storage medium (434) may be, for example, Random Access Memory (RAM), a storage drive, an optical disc, and the like. The machine-readable storage medium (434) may be disposed within the computing system (430), as shown in FIG. 4. In this situation, the executable instructions may be “installed” on the computing system (430). In one example, the machine-readable storage medium (434) may be a portable, external or remote storage medium, for example, that allows the computing system (430) to download the instructions from the portable/external/remote storage medium. In this situation, the executable instructions may be part of an “installation package”. As described herein, the machine-readable storage medium (434) may be encoded with executable instructions for detecting a failing component in a device.

Referring to FIG. 4, power specifications instructions (436), when executed by a processor (432), may cause the computing system (430) to determine power specifications and control operations available for a printbar (FIG. 1, 104) of a printer (FIG. 1, 102) coupled to the remote printer control device (FIG. 1, 100). Power supply instructions (438), when executed by a processor (432), may cause the computing system (430) to provide power to the remote printer control device (FIG. 1, 100) and the printbar (FIG. 1, 104) based on the determined power specifications for the printbar (FIG. 1, 104). Printbar control instructions (440), when executed by a processor (432), may cause the computing system (430) to control the printbar (FIG. 1, 104) based on the determined control operations available for the printbar (FIG. 1, 104). Update instructions (442), when executed by a processor (432), may cause the computing system (430) to provide at least one of an update and a command to a service board (FIG. 3, 322) of the printbar (FIG. 1, 104).

In some examples, the processor (432) and machine-readable storage medium (434) are located within the same physical component, such as a server, or a network component. The machine-readable storage medium (434) may be part of the physical component's main memory, caches, registers, non-volatile memory, or elsewhere in the physical component's memory hierarchy. In one example, the machine-readable storage medium (434) may be in communication with the processor (432) over a network. Thus, the computing system (430) may be implemented on a user device, on a server, on a collection of servers, or combinations thereof.

The computing system (430) of FIG. 4 may be part of a general-purpose computer. However, in some examples, the computing system (430) is part of an application specific integrated circuit.

In one example, using such a remote printer control device 1) allows for printbar control in the event of power outage, 2) allows printbar and other printer maintenance while the printer is disconnected from an operational power supply, and 3) provides increased control over the different components of the printer. However, it is contemplated that the devices disclosed herein may address other matters and deficiencies in a number of technical areas.

The preceding description has been presented to illustrate and describe examples of the principles described. This description is not intended to be exhaustive or to limit these principles to any precise form disclosed. Many modifications and variations are possible in light of the above teaching.

What is claimed is:

1. A remote printer control device comprising:
a power supply;
a power interface to provide power from the power supply to a printbar when an operational power supply for a printer in which the printbar is installed is disengaged; and
a controller to interface with, and control, the printbar when the operational power supply for the printer is disengaged.

2. The device of claim 1, wherein control of the printbar comprises placing the printbar in a desired state.

3. The device of claim 1, wherein control of the printbar comprises manipulating individual motors coupled to the printbar.

4. The device of claim 1, wherein the controller and the power interface selectively couple to corresponding interfaces on a service board that is uniquely paired with a particular printbar.

5. The device of claim 1, wherein the remote printer control device is separate from the printer to which it is coupled.

6. The device of claim 1, further comprising a database of power specifications and control operations for multiple printers.

7. The device of claim 6, further comprising a selector to:
indicate a printer type that the remote printer control device is coupled to; and
retrieve, from the database, the power specifications and control operations for the printer that the remote printer control device is coupled to.

8. The device of claim 7, wherein the selector is a mechanical selector.

9. A remote printer control device comprising:
a power supply to provide power to the remote printer control device and a printbar of a printer;
a power converter to determine power specifications of the printbar to which the remote printer control device is coupled;
a power interface to provide power from the power supply to the printbar when an operational power supply for the printer is disengaged, which power is based on the determined power specifications of the printbar;
a controller to interface with, and control, the printbar when the operational power supply for the printer is disengaged; and
a user interface to facilitate control over the printbar.

10. The device of claim 9, wherein control of the printbar comprises placing the printbar in a capped state.

11. The device of claim 9, wherein the printbar in a page-wide printbar.

12. The device of claim 9, wherein the remote printer control device is interchangeable between different printers.

13. The device of claim 9, wherein the remote printer control device is interchangeable between, and individually controls, different printbars at different points in time.

14. A computing system comprising:
a processor;
a machine-readable storage medium coupled to the processor; and
an instruction set, the instruction set being stored in the machine-readable storage medium to be executed by the processor, wherein the instruction set comprises;
instructions to determine power specifications and control operations available for a printbar of a printer coupled to the remote printer control device;
instructions to provide power to the remote printer control device and the printbar based on the determined power specifications for the printbar; and
instructions to control the printbar based on the determined control operations available for the printbar.

15. The computing system of claim 14, wherein the instruction set further comprises instructions to provide at least one of updates and commands to a service board of the printbar.
